(19) United States
(12) Patent Application Publication
(10) Pub. No.: US 2013/0054785 A1
(43) Pub. Date: Feb. 28, 2013

(54) COMMUNICATIONS PATH DISCOVERY

(71) Applicant: Samarjit Adhikari, Bangalore (IN)

(72) Inventor: Samarjit Adhikari, Bangalore (IN)

(21) Appl. No.: 13/220,238

(22) Filed: Aug. 29, 2011

(51) Int. Cl. G06F 15/173

(52) U.S. Cl. 709/224

(57) ABSTRACT

In one implementation, a plurality of candidate output addresses are identified for an intermediate entity and a data packet is provided to a candidate output address from the plurality of candidate output addresses. The candidate output address is defined as the output address of the intermediate entity if a response to the data packet was provided from the input address of the intermediate entity.

### BACKGROUND

A communications path between a source device and a destination device can be identified, determined, or discovered by accessing information related to the source device, destination device, intermediate entities logically between the source device and destination device using network management protocols, network management tools, and/or network management agents. One such methodology uses the Simple Network Management Protocol (SNMP). For example, a communications path discovery system can query a Management Information Base (MIB) at the intermediate entities using community strings to identify the input and output addresses of the intermediate entities.

Although such methodologies can be used to discover communications paths, these methodologies are reliant on the supporting protocols, tools, and/or agents at the intermediate entities. In the absence of support for or implementations of such protocols, tools, and/or agents at the intermediate entities, such methodologies can fail to function. Furthermore, such methodologies can be inoperative in environments that do not allow such protocols, tools, or agents. For example, network devices at the edge of communications networks (e.g., gateways, bridges, firewalls, network address translators, or proxies) can block or inhibit such protocols.

### BRIEF DESCRIPTION OF THE DRAWINGS

FIG. 1 is an illustration of an environment including a communications path discovery system, according to an implementation.

FIG. 2 is a flowchart of a process to define a communications path, according to an implementation.

FIG. 3 is a schematic block diagram of communications path discovery system, according to an implementation.

FIG. 4 is a schematic block diagram of a computing device configured as a communications path discovery system, according to an implementation.

### DETAILED DESCRIPTION

Communications paths through or within communication links can be defined at intermediate entities of those communications links. For example, routers within a packet-switching communications network can include routing or forwarding tables that define the address or device to which data packets should be sent along a communications path to a destination device. Because this forwarding or routing information is distributed across the devices in a communications path, a source device often is not aware of or does not include a description of the communications path. In other words, a source device may not know along what communications path data packets are sent to a destination device.

Implementations discussed herein determine (or discover or identify) communications paths between source devices and destination devices without relying on SNMP or other network management protocols, tools, or agents. For example, implementations discussed herein can determine communications paths using information that is accessible at an Internet Protocol (IP) stack such as a User Datagram Protocol (UDP) or Transport Control Protocol (TCP) IP stack and data packets including particular data or field values. As a specific example, implementations discussed herein can identify communications paths using standard components of an IP stack such as Internet Control Message Protocol (ICMP) and UDP rather than leveraging additional network management protocols, tools, or agents included at intermediate entities along a communications path. Additionally, implementations discussed herein can generate communications path descriptors that include the addresses of a source device, intermediate devices, and a destination device of a communications path.

As used herein, the singular forms “a,” “an,” and “the” include plural referents unless the context clearly dictates otherwise. Thus, for example, the term “data packet” is intended to mean one or more data packets or a combination of data packets.

Additionally, as used herein, the term “module” refers to a combination of hardware (e.g., a processor such as an integrated circuit or other circuitry) and software (e.g., machine- or processor-executable instructions, commands, or code such as firmware, programming, or object code). A combination of hardware and software includes hardware only (i.e., a hardware element with no software elements), software hosted at hardware (e.g., software that is stored at a memory and executed or interpreted at a processor), or at hardware and software hosted at hardware. Furthermore, as used herein, the phrases “at an address,” “at address X,” “to address X,” and similar phrases refer to some action (e.g., output or receipt of data) relative to (e.g., at or to) a communications interface or a device with a communications interface associated with that address.

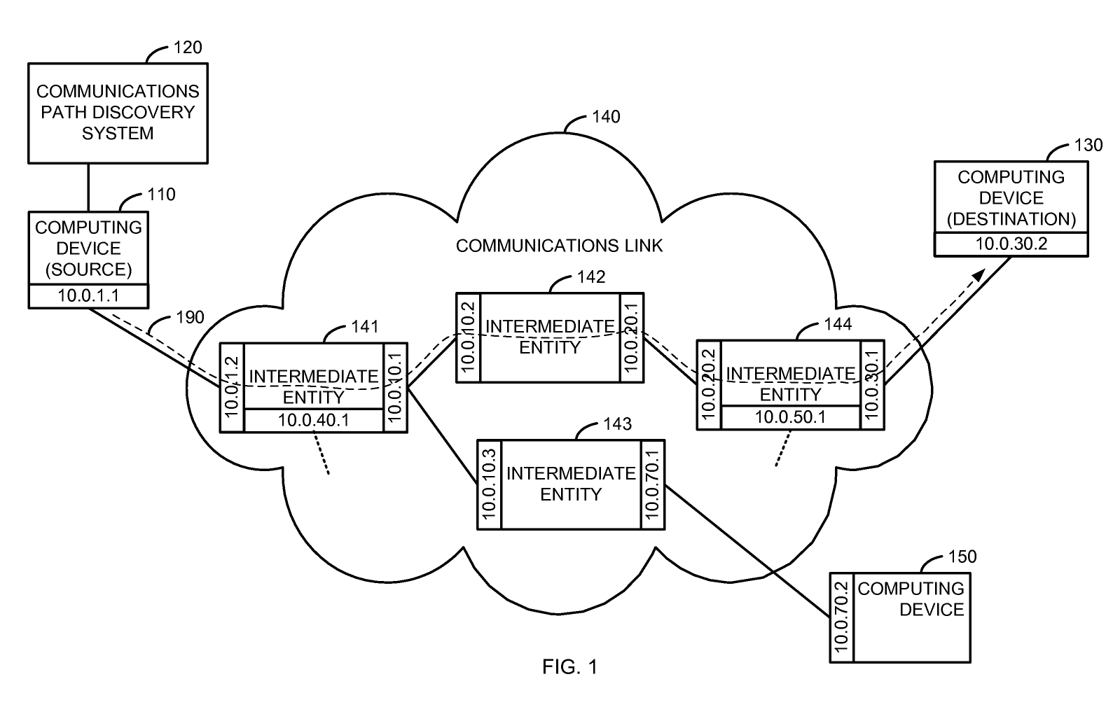

FIG. 1 is an illustration of an environment including a communications path discovery system, according to an implementation. Computing devices 110, 130, and 150 are in communication one with another via communications link 140. Communications path discovery system 120 is in communication with computing device 110, and identifies or discovers communications path 190 between computing devices 110 and 130. As a specific example, communications path discovery system 120 identifies addresses of devices in communications path 190.

Communications link 140 includes devices, services, or combinations thereof that support communication (i.e., exchange of signals or symbols representing information or data) between computing device 110, computing device 130, computing device 150 or other devices or services (not illustrated). For example, communications link 140 can include one or more of a cable (e.g., twisted-pair cable, coaxial cable, or fiber optic cable), a wireless link (e.g., radio-frequency link, optical link, or sonic link), or any other connectors or systems that transmit or support transmission of signals. Accordingly, computing device 110, computing device 130, computing device 150 can be coupled to communication link 140 using cables (e.g., electrical or optical cables) or wirelessly.

The connections or communications paths illustrated in FIG. 1 are logical and do not necessarily reflect physical connections. For example, communications link 140 can include communications networks such as an intranet, the Internet, telecommunications networks, or a combination thereof. Additionally, communications link 140 can include access points (e.g., devices via which other devices can be connected or coupled to a communications network and/or additional devices), proxies, routers, switches, gateways, bridges, load balancers, and similar communications devices. More specifically, as illustrated in FIG. 1, communications link 140 includes intermediate entities 141, 142, 143, and 144.

Intermediate entities 141-144 are communications devices such as proxies, routers, switches, gateways, bridges, load balancers, similar communications devices or services, or combinations thereof via which communications link 140 or portions thereof are realized. That is, intermediate entities 141-144 are logically located within communications link 140 between computing devices 110, 130, and 150. In the example illustrated in FIG. 1, communications link 140 is illustrated as a packet-switching communications network with intermediate entities 141-144.

Additionally, intermediate entities 141-144 include communications interfaces that are associated with unique addresses within communications link 140. Addresses are identifiers or references that identify devices (e.g., intermediate entities) or communications interfaces thereof within a communications link such as a communications network. For example, addresses can be unique device identifiers, Internet Protocol version 4 (IPv4), Internet Protocol version 6 (IPv6), medium access control (MAC) addresses, or other identifiers or references.

As illustrated in FIG. 1, the interfaces of intermediate entities 141-144 are associated with Internet Protocol version 4 (IPv4) addresses. More specifically, intermediate entity 141 includes first, second, and third communications interfaces associated with addresses 10.0.1.2, 10.0.10.1, and 10.0.40.1, respectively. The third communications interface of intermediate entity 141 (associated with address 10.0.40.1 is in communication with or operatively coupled to other intermediate entities not illustrated in FIG. 1. Intermediate entity 142 includes first and second communications interfaces associated with addresses 10.0.10.2 and 10.0.20.1, respectively. Intermediate entity 143 includes first and second communications interfaces associated with addresses 10.0.10.3 and 10.0.70.1, respectively. Intermediate entity 144 includes first, second, and third communications interfaces associated with addresses 10.0.20.2, 10.0.30.1, and 10.0.50.1, respectively. The third communications interface of intermediate entity 144 (associated with address 10.0.50.1 is in communication with or operatively coupled to other intermediate entities not illustrated in FIG. 1. Similarly, computing devices 110, 130, and 150 each include a communications interface associated with addresses 10.0.1.1, 10.0.30.2, and 10.0.70.2, respectively.

Communications path 190 illustrates the flow of data packets sent from computing device 110 (the source or source device of these data packets) to computing device 130 (the destination or destination of these data packets). A communications path includes communications interfaces, devices, services, or combinations thereof between a source device (e.g., a computing device that sends a data packet to a destination) and a destination device (e.g., the computing device to which data packet is sent). The communications interfaces, devices, services, or combinations thereof included at a communications path can be said to be “along”, “at”, “included at”, “included in”, or otherwise associated with that communications path.

Specifically with reference to communications path 190, data packets sent from computing device 110 to computing device 130 are output from the communications interface of computing device 110 (or from address 10.0.1.1) and received at the first communications interface (associated with the address 10.0.1.2) of intermediate entity 141 (or at address 10.0.1.2). The data packets are then output at the second communications interface (associated with the address 10.0.10.1) of intermediate entity 141 and received at the first communications interface (associated with the address 10.0.10.2) of intermediate entity 142. Next, the data packets are output at the second communications interface (associated with the address 10.0.20.1) of intermediate entity 142 and received at the first communications interface (associated with the address 10.0.20.2) of intermediate entity 144. The data packets are then output at the second communications interface (associated with the address 10.0.30.1) of intermediate entity 144 and received at the communications interface of computing device 130. Thus, communications path 190 includes those communications interfaces and devices (e.g., computing devices and intermediate entities).

Addresses 10.0.1.2, 10.0.10.2, and 10.0.20.2 can be referred to as input addresses relative to communications path 190. Input addresses are addresses associated with interfaces at which data packets are received along a communications path. Similarly, addresses, 10.0.10.1, 10.0.20.1, and 10.0.30.1 can be referred to as output addresses relative to communications path 190. Output addresses are addresses associated with interfaces at which data packets are output along a communications path. In some implementations, an input address can also be an output address or, conversely, an output address can also be an input address based on, for example, a topology of devices within a communications link such as a communications network.

Communications paths can be described by a communications path descriptor with reference to the addresses of the communications interfaces (or devices including those communications interfaces). In other words, a communications path descriptor includes a group of addresses to define or describe a communications path. As an example, communications path 190 can be described by the following group of addresses: 10.0.1.1, 10.0.1.2, 10.0.10.1, 10.0.10.2, 10.0.20.1, 10.0.20.2, 10.0.30.1, and 10.0.30.2.

Communications path discovery system 120 identifies addresses of devices in communications path 190 by providing probe requests and specifically formatted data packets (e.g., data packets with particular data or field values) to computing device 130 and/or intermediate entities within communications link 140 via computing device 110. In some implementations, communications path discovery system 120 is separate from computing device 110 as illustrated in FIG. 1. In other implementations, communications path discovery system 120 is included, executed, or hosted at computing device 110.

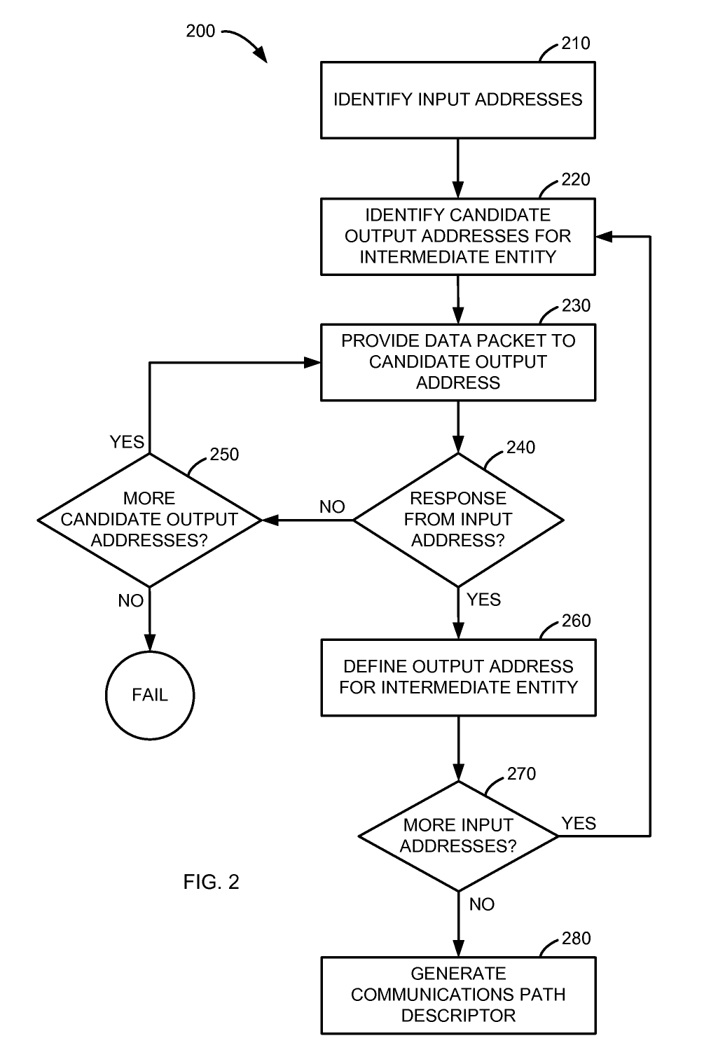

As an example of the operation of a communications path discovery system such as communications path discovery system 120, FIG. 2 is a flowchart of a process to define a communications path, according to an implementation. Process 200 is discussed herein with reference to components of the environment illustrated in FIG. 1. Specifically, process 200 is discussed as implemented at communications path discovery system 120. In other implementations, process 200 can be applicable to other components and/or other environments. Moreover, in other implementations, process 200 can include fewer, additional, and/or rearranged blocks or steps. For example, in some implementations, multiple iterations of blocks 220, 230, 240, 250, and 260 can be implemented in parallel.

At block 210, communications path discovery system 120 first determines the input addresses of intermediate entities along communications path 190. For example, communications path discovery system 120 can use a network diagnostic or discovery tool or application such as a traceroute tool at communications path discovery system 120 to determine input addresses along communications path 190. As a specific example, communications path discovery system 120 sends (e.g., directly or via computing device 110) via address 10.0.1.1 a data packet such as a User Datagram Protocol (UDP) packet with a low time-to-live (TTL) value to address 10.0.30.2. A TTL value defines through how many devices (or across how many hops) a data packet should be sent. For example, the TTL value of a data packet can be decremented at each intermediate entity implementing a network stack such as an IPv4 network stack that includes the Internet Control Message Protocol (ICMP). If the TTL value reaches zero (or some other minimum value) before the data packet arrives at the destination address (here, 10.0.30.2), the intermediate entity that last received the data packet sends an ICMP error response to the source address (here, 10.0.1.1) from the input address at which the data packet was received.

Accordingly, communications path discovery system 120 sends, for example, a data packet with a TTL value of 1 to address 10.0.30.2. The data packet is received at address 10.0.1.2 of intermediate entity 141, and the TTL value is decremented. Because the TTL value has reached 0, an error response is sent from address 10.0.1.2 (an input address relative to communications path 190 and the address of the communications interface at which the data packet was last received) to address 10.0.1.1 (the source of the data packet). Communications path discovery system 120 receives the error response (e.g., directly or via computing device 110) and extracts input address 10.0.1.2. Communications path discovery system 120 stores or logs input address 10.0.1.2, and sends another data packet to address 10.0.30.2 with a TTL value that is one greater than the TTL value of the previous data packet or, here, a TTL value of 2.

This data packet similarly results in an error response sent from input address 10.0.10.2. More specifically, the data packet is sent from address 10.0.1.1 to address 10.0.30.2, and is first received at address 10.0.1.2. The TTL value of the data packet is reduced by 1 from 2 to a value of 1 at intermediate entity 141, and sent or forwarded from address 10.0.10.1 to address 10.0.10.2. The TTL value of the data packet is reduced by 1 from 1 to 0 at intermediate entity 142. An error response is then sent from address 10.0.10.2 to address 10.0.1.1.

Communications path discovery system 120 extracts input address 10.0.10.2 from the error response, stores input address 10.0.10.2, and sends another packet to address 10.0.30.2 with a TTL value that is one greater than the TTL value of the previous data packet or, here, a TTL value of 3. Similarly, this data packet results in an error response sent from input address 10.0.20.2. Communications path discovery system 120 extracts input address 10.0.20.2 from the error response, stores input address 10.0.20.2, and sends another packet to address 10.0.30.2 with a TTL value that is one greater than the TTL value of the previous data packet or, here, a TTL value of 4.

This data packet reaches address 10.0.30.2 (i.e., an input address of computing device 130) before the TTL value is decremented to 0. An error response is sent from address 10.0.30.2 to address 10.0.1.1 in response to the TTL value being decremented to 0. Communications path discovery system 120 extracts input address 10.0.30.2 from the error response, and determines that the data packet has reached its destination because the address extracted from the error response is the same as the address of the destination.

In other implementations, no error response is sent from computing device 130 or received at communications path discovery system 120 in response to to the TTL value being decremented to 0 at input address 10.0.30.2 of computing device 130. Communications path discovery system 120 can determine that the data packet has reached its destination because no error response was received (e.g., before a timeout or other predetermined period expires). In yet other implementations, a success response can be sent from address 10.0.30.2 of computing device 130 when the data packet is received, and communications path discovery system 120 can determine that the data packet has reached its destination based on the success response.

Based on the determination that the data packet was received at its destination (here, input address 10.0.30.2 of computing device 130), communications path discovery system 120 determines that is has identified each input address along communications path 190. In other words, communications path discovery system 120 can determine that three intermediate entities exist along communications path 190 (or logically between computing device 110 and computing device 130) with input addresses 10.0.1.2, 10.0.10.2, and 10.0.20.2, respectively.

After identifying input addresses at block 210, candidate output addresses are identified for an intermediate entity at block 220. As illustrated in FIG. 2, blocks 220, 230, 240, 250, and 260 are repeated for each input address (or intermediate entity). Accordingly, the intermediate entity for an iteration of these blocks can be referred to as the current intermediate entity. In the first iteration of these blocks, the first intermediate entity (e.g., intermediate entity 141 in FIG. 1) can be the current intermediate entity. In the next iteration of these blocks, the subsequent intermediate entity (i.e., the next intermediate entity along the communications path) to the current intermediate entity (here, intermediate entity 142 is the subsequent intermediate entity to intermediate entity 141) can be the current intermediate entity. Such iterations can be repeated until there is no subsequent intermediate entity (i.e., the next device along the communications path is the destination of the communications path).

Candidate output addresses are addresses that may be an output address of an intermediate entity. For example, candidate output addresses of an intermediate entity include properties or characteristics that are consistent with an output address of that intermediate entity. Such properties or characteristics can be the same as or similar to those of an input address of a subsequent intermediate entity with which the intermediate entity communicates via its output address. Accordingly, an candidate output addresses of an intermediate entity can be derived from or based on properties or characteristics of an input address of a subsequent intermediate entity. As a specific example, candidate output addresses of an intermediate entity can be within an address range (or range or group of addresses) that includes an input address of a subsequent intermediate entity in a communications path.

In an example implementation, candidate output addresses of the current intermediate entity are identified at block 220 as follows. Communications path discovery system 120 accesses the input address of the subsequent intermediate entity to the current intermediate entity, and provisionally selects each address within a range of addresses including the input address of the subsequent intermediate entity as candidate output addresses. For example, with reference to the first iteration of blocks 220, 230, 240, 250, and 260, communications path discovery system 120 provisionally selects each address from 10.0.10.1 to 10.0.10.255 as the candidate output addresses for intermediate entity 141 because the input address of intermediate entity 142 (the current subsequent intermediate entity) is 10.0.10.2. That is, communications path discovery system 120 can assume a subnet mask of 255.255.255.0 (or /24) for the input address of current subsequent intermediate entity and the output address of the current intermediate entity (or the section of communications link 140 including these addresses).

Alternatively, for example, communications path discovery system 120 can request a subnet mask or other description of addresses for a section of communications link 140. As a specific example, communications path discovery system 120 can send an ICMP address mask request to input address 10.0.10.2 (i.e., the address to which the current intermediate entity forwards data packets along the communications path), and receive an address mask for the first communications interface of intermediate entity 142 (i.e., the communications interface of intermediate entity 142 associated with the input address 10.0.10.2). Because the output address on the current intermediate entity and the input address of the subsequent intermediate entity are typically associated with a common network segment, these addresses often share a common address mask. Communications path discovery system 120 can therefore provisionally select addresses within an address range defined by that address mask (e.g., a subnet mask) as candidate output addresses of intermediate entity 141 (the current intermediate entity).

In some implementations, after provisionally selecting the candidate output addresses, communications path discovery system 120 determines which addresses of the candidate output addresses are active addresses. Active addresses are addresses that are associated with a device such as an intermediate entity or an interface thereof. For example, given the addresses illustrated in FIG. 1, there are three active addresses in the address range of 10.0.10.1 to 10.0.10.255-10.0.10.1, 10.0.10.2, and 10.0.10.3. The remaining addresses are inactive addresses (e.g., are not associated with devices in the environment illustrated in FIG. 1).

Communications path discovery system 120 can determine which addresses of the candidate output addresses are active addresses by sending probe requests to each of the candidate output addresses provisionally selected above. A probe request is a data packet that includes codes or instructions to request that a device such as an intermediate entity or computing device take some action relative to the probe request. For example, a probe request can request that the recipient (e.g., an intermediate entity with a communications interface associated with the address at or to which the probe request was provided) respond to or acknowledge the probe request. If a response or acknowledgement is received, communications path discovery system 120 can determine that the address is active. If a response or acknowledgement is not received, communications path discovery system 120 can determine that the address is not active. Thus, probe requests can be used to determine whether an address is associated with a device. As a specific example, a ping tool or application can be used to issue ICMP echo requests as probe requests.

Alternatively, for example, an attempt to establish connection-oriented communications session such as a Transport Control Protocol (TCP) session can be made at an address as a probe request. If the connection-oriented communications session is established, communications path discovery system 120 can determine that the address is active. If the connection-oriented communications session is not established, communications path discovery system 120 can determine that the address is not active.

Communications path discovery system 120 can discard the candidate output addresses that were determined to be inactive, and identify the remaining candidate output addresses as candidate output addresses for the current intermediate entity. In other implementations, candidate output addresses selected above are not provisionally selected. Rather, communications path discovery system 120 does not determine that these candidate output addresses selected above are active addresses, and these candidate output addresses are identified as the candidate output addresses for the current intermediate entity. In other words, in some implementations, communications path discovery system 120 does not verify that the candidate output addresses for the current intermediate entity are active addresses.

Data packets are then sent from communications path discovery system 120 to the candidate output addresses to identify which candidate output address from the candidate output addresses is an output address of the current intermediate entity relative to the communications path. For example, as illustrated in FIG. 2, a data packet is provided (e.g., sent) to a candidate output address from the candidate output addresses. The data packet can be a formatted or include particular values or characteristics that cause a response to be provided from the input address of the current intermediate entity if the candidate output address is an output address of the current intermediate entity.

For example, for a UDP data packet, the destination port identifier of the UDP data packet can be set to a value that is not associated with a resource (e.g., a network resource or service) at the candidate output address. Said differently, the destination portion identifier can be set to a value at which no resource is available at the communications interface of the current intermediate entity associated with the candidate output address. As a specific example, the destination port identifier can be set to a value above (or higher than) the value of ports that are typically open at a firewall or operating system to the communications interface of the current intermediate entity associated with the candidate output address.

If the candidate output address is an output address of the current intermediate entity, a response to the data packet indicating that there is no resource available at the port identified in the data packet is provided to (or received by) communications path discovery system 120 from the input address of the current intermediate entity at block 240. As a specific example, an ICMP port unreachable error response is provided to communications path discovery system 120 from the input address of the current intermediate entity. If, however, the candidate output address is not an output address of the current intermediate entity, a response to the data packet indicating that there is no resource available at the port identified in the data packet is provided to communications path discovery system 120 from an address other than the input address of the current intermediate entity at block 240. Accordingly, based on the response to the data packet, communications path discovery system 120 can determine whether the candidate output address is an output address of the current intermediate entity.

If the response to the data packet is not received from the input address of the current intermediate entity at block 240, the candidate output address is discarded (or no longer considered), and process 200 proceeds to block 230 if there are more candidate output addresses at block 250. In other words, if there are more candidate output addresses at block 250, data packets are provided to those candidate output addresses. If there are no more candidate output addresses at block 250, process 200 fails because no output address for the current intermediate entity was identified. A user such as a system administrator of, for example, communications path discovery system 120 can be notified of the failure via electronic communications such as electronic mail, instant messaging, or paging or via output at a user interface such as a graphical user interface (GUI) or command line interface (CLI).

If the response to the data packet is received from the input address of the current intermediate entity at block 240, the output address for the current intermediate entity is defined as the candidate output address to which the data packet was provided at block 230. For example, that candidate output address can be stored at a memory location, database, or table as the output address of the current intermediate entity. Alternatively, for example, a flag or other value related to that candidate output address can be set or assigned a value to indicate that that candidate output address is the output address of the current intermediate entity.

If there are more input addresses (or intermediate entities) at block 270, process 200 returns to block 230 to identify the output addresses relative to the communications path (here, communications path 190) of the intermediate entities associated with those input addresses (e.g., the intermediate entities with communications interfaces having those input addresses).

If there are no more input addresses at block 270, a communications path descriptor that identifies the addresses of the devices along the communications path is generated (or defined) at block 280. For example, the communications path descriptor can be a list of the address of the source computing device, input addresses and output addresses of intermediate devices, and destination computing device along the communications path. In some implementations, input addresses and output addresses of intermediate devices can be grouped per intermediate device or annotated to indicate for which intermediate device each input address and output address is an input address or output address, respectively.

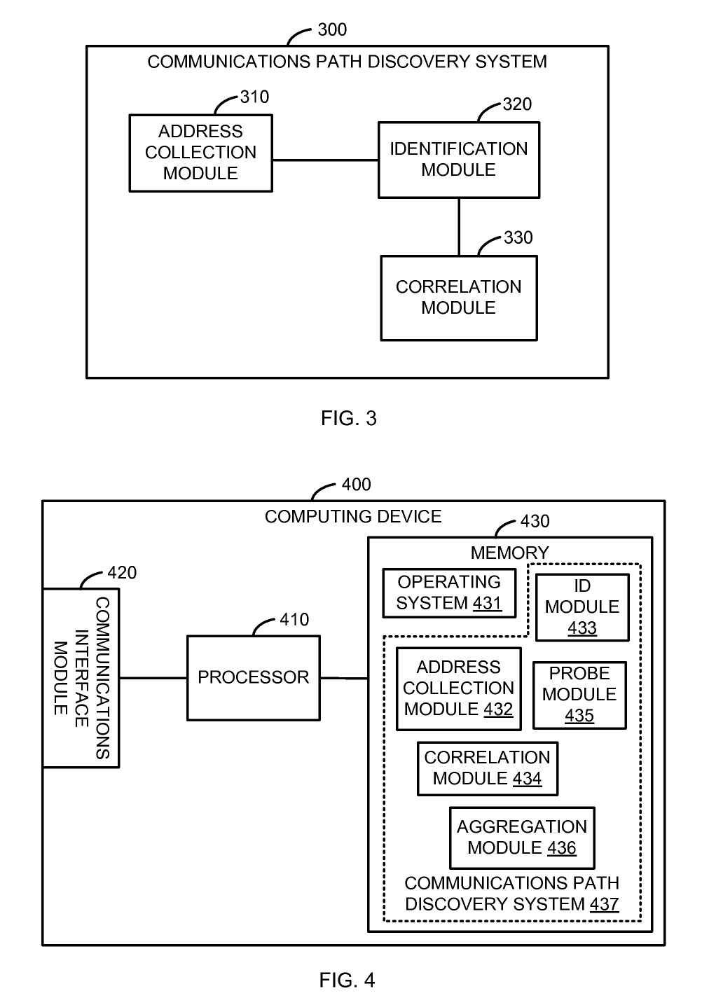

FIG. 3 is a schematic block diagram of communications path discovery system, according to an implementation. Although various modules (i.e., combinations of hardware and software) are illustrated and discussed in relation to FIGS. 3 and 4 and other example implementations, other combinations or sub-combinations of modules can be included within other implementations. Said differently, although the modules illustrated in FIGS. 3 and 4 and discussed in other example implementations perform specific functionalities in the examples discussed herein, these and other functionalities can be accomplished at different modules or at combinations of modules. For example, two or more modules illustrated and/or discussed as separate can be combined into a module that performs the functionalities discussed in relation to the two modules. As another example, functionalities performed at one module as discussed in relation to these examples can be performed at a different module or different modules.

As illustrated in FIG. 3, communications path discovery system 300 includes address collection module 310, identification module 320, and correlation module 330. Address collection module 310 collects or identifies input addresses of intermediate entities along a communications path between a source device and a destination device. For example, address collection module 310 can identify input addresses using a methodology similar to the methodology discussed above in relation to block 210 of process 200 illustrated in FIG. 2.

Identification module 320 receives the input addresses collected at address collection module 310, and identifies a group of candidate output addresses for the intermediate entity associated with each input address. For example, identification module 320 can identify candidate output addresses as discussed above in relation to process 200. In some implementations, identification module 320 receives the input addresses from a module, service, or data store other than address collection module 310. That is, identification module 320 can access the input addresses at an internal module, service, or data store or at an external module, service, or data store.

Correlation module 330 receives the candidate output addresses for each intermediate entity (e.g., from identification module 320 or from another module, service, or data store), and determines which candidate output address is the output address for that intermediate entity relative to the communications path including the input addresses. In other words, correlation module 330 correlates an output address with each input address. In one implementation, correlation module 330 correlates an output address with an input address as discussed above in relation to blocks 230, 240, 250, and 260 of process 200 illustrated in FIG. 2.

Communications path discovery system 300 can be a computing appliance or virtualized appliance in communication with a source device along a communications path and define a communications path between the source device and a destination device. In some implementations, communications path discovery system 300 can communicate with an agent at the source device (e.g., a module hosted at the source device) to define the communications path. That is, for example, communications path discovery system 300 can communicate with the agent to perform process 200 illustrated in FIG. 2.

In other implementations, a communications path discovery system can be hosted at a computing device such as a source device along a communications path. As an example, of such an implementation, FIG. 4 is a schematic block diagram of a computing device configured as a communications path discovery system, according to an implementation. For example, as illustrated in FIG. 4, computing device 400 hosts or executes address collection module 432, identification module (labeled “ID MODULE”) 433, correlation module 434, probe module 435, and aggregation module 436 at processor 410, causing processor 410 (or computing device 400) to function or operate as a communications path discovery system. As a specific example, address collection module 432, identification module 433, correlation module 434, probe module 435, and aggregation module 436 can each include instructions or code that when executed at processor 410 cause processor 410 (alone or together with other components of computing device 400) to perform process 200 discussed above in relation to FIG. 2.

Computing device 400 includes processor 410, communications interface module 420, and memory 430. Processor 410 is any combination of hardware and software that executes or interprets instructions, codes, or signals. For example, processor 410 can be a microprocessor, an application-specific integrated circuit (ASIC), a distributed processor such as a cluster or network of processors or computing device, or a virtual machine.

Communications interface module 420 is a module in communication with processor 410 via which computing device 400 communicates (e.g., exchange symbols or signals representing data or information) with other computing devices and/or services via, for example, a communications link. Communications interface module 420 can include hardware (e.g., pins, connectors, or integrated circuits) and software (e.g., drivers or communications stacks). For example, communications interface module 420 can implement an electrical communications interface, an optical communications interface, a wireless communications interface, an Ethernet interface, a Fiber Channel interface, an InfiniBand interface, or another communications interface.

Memory 430 is a non-transitory processor-readable medium that stores instructions, codes, data, or other information. For example, memory 430 can be a volatile random access memory (RAM), a persistent data store such as a hard disk drive or a solid-state drive, or a combination thereof or other memories. Furthermore, memory 430 can be integrated with processor 410, separate from processor 410, or external to computing device 400.

As illustrated in FIG. 4, memory 430 includes operating system, 431 address collection module 432, identification module 433, correlation module 434, probe module 435, and aggregation module 436. Address collection module 432, identification module 433, correlation module 434, probe module 435, and aggregation module 436 can be collectively referred to as communications path discovery system 437. Address collection module 432, identification module 433, and correlation module 434 are similar to address collection module 310, identification module 320, and correlation module 330 discussed above in relation to FIG. 3.

Probe module 435 provides probe requests to intermediate entities and receives related responses from intermediate entities. Additionally, probe module 435 determines whether a response has been received in response to a probe request.

Aggregation module 436 aggregates or groups input addresses and output addresses into a communications path. That is, aggregation module accesses input addresses and output addresses of intermediate entities identified by, for example, identification module 433 and correlation module 434, and groups these input addresses and output addresses into a communications path. In some implementations, aggregation module outputs communications path descriptors to a user of computing device. For example, a representation such as a textual and/or graphical representation of the communications path descriptor (or the communications path itself) can be provided to a user via communications interface module 420. In other implementations, computing device 400 can include an output module such as a display or display interface at which a representation of the communications path can be output at a GUI or CLI.

Operating system 431, address collection module 432, identification module 433, correlation module 434, probe module 435, and aggregation module 436 are each instructions or code that—when executed at processor 410—cause processor 410 to perform operations that implement, respectively, a communications path discovery system. Said differently, operating system 431 and communications path discovery system 437 are hosted at computing device 400. For example, the instructions or codes of communications path discovery system 437 can cause processor 410 to access or interact with communications interface module 420 to send and/or receive data packets, probe requests, or other data or information to define a communications path.

In some implementations, computing device 400 can be a virtualized computing device. For example, computing device 400 can be hosted as a virtual machine at a computing server. Moreover, in some implementations, computing device 400 can be a virtualized computing appliance, and operating system 431 is a minimal or just-enough operating system to support (e.g., provide services such as a communications stack and access to components of computing device 400 such as communications interface module 420) communications path discovery system 437.

Communications path discovery system 437 (or address collection module 432, identification module 433, correlation module 434, probe module 435, aggregation module 436, and/or other modules included therein) can be accessed or installed at computing device 400 from a variety of memories or processor-readable media. For example, computing device 400 can access a remote processor-readable medium via communications interface module 420 and access communications path discovery system 437at that processor-readable medium. As a specific example, computing device 400 can be a thin client that accesses operating system 431 and communications path discovery system 437 during a boot sequence.

As another example, computing device 400 can include (not illustrated in FIG. 4) a processor-readable medium access device (e.g., a compact disc (CD), digital video disc (DVD″), Secure Digital™ (SD), MultiMediaCard (MMC), or a CompactFlash™ (CF) drive or reader) and access communications path discovery system 437 at a processor-readable medium via that processor-readable medium access device. As a more specific example, the processor-readable medium access device can be a DVD drive at which a DVD including an installation package for communications path discovery system 437is accessible. The installation package can be executed or interpreted at processor 410 to install communications path discovery system 437 at computing device 400 (e.g., at memory 430). Computing device 400 can then host or execute communications path discovery system 437.

In some implementations, address collection module 432, identification module 433, correlation module 434, probe module 435, aggregation module 436, and/or other modules of communications path discovery system 437 can be accessed at or installed from multiple sources, locations, or resources. For example, some of address collection module 432, identification module 433, correlation module 434, probe module 435, and aggregation module 436 can be installed via a communications link, and others of address collection module 432, identification module 433, correlation module 434, probe module 435, and aggregation module 436 can be installed from a DVD.

While certain implementations have been shown and described above, various changes in form and details may be made. For example, some features that have been described in relation to one implementation and/or process can be related to other implementations. In other words, processes, features, components, and/or properties described in relation to one implementation can be useful in other implementations. As another example, functionalities discussed above in relation to specific modules or elements can be included at different modules, engines, or elements in other implementations. Furthermore, it should be understood that the systems, apparatus, and methods described herein can include various combinations and/or sub-combinations of the components and/or features of the different implementations described. Thus, features described with reference to one or more implementations can be combined with other implementations described herein.

What is claimed is:

1. A processor-readable medium storing code representing instructions that when executed at a processor cause the processor to:
identify a plurality of candidate output addresses from an address range for an intermediate entity;
provide a data packet to a candidate output address from the plurality of candidate output addresses;
determine whether a response to the data packet was provided from an input address of that intermediate entity; and
define the candidate output address as an output address of the intermediate entity if the response to the data packet was provided from the input address of the intermediate entity.

2. The processor-readable medium of claim 1, further storing code representing instructions that when executed at a processor cause the processor to discard the candidate output address if the response to the data packet was not provided from the input address of the intermediate entity.

3. The processor-readable medium of claim 1, further storing code representing instructions that when executed at a processor cause the processor to generate the address range based on an input address associated with a subsequent intermediate entity of the intermediate entity.

4. The processor-readable medium of claim 1, further storing code representing instructions that when executed at a processor cause the processor to:
request an address mask from a subsequent intermediate entity; and
generate the address range based on the address mask and an input address associated with a subsequent intermediate entity.

5. The processor-readable medium of claim 1, further storing code representing instructions that when executed at a processor cause the processor to provide a probe request to each candidate output address from the plurality of candidate output addresses before the data packet is provided to the candidate output address.

6. The processor-readable medium of claim 1, wherein the data packet includes a port identifier that is not associated with a resource at the candidate output address.

7. The processor-readable medium of claim 1, wherein the response is a port unreachable response.

8. The processor-readable medium of claim 1, further storing code representing instructions that when executed at a processor cause the processor to repeat the identifying, providing, determining, and defining for each intermediate device in a communications link.

9. The processor-readable medium of claim 1, further storing code representing instructions that when executed at a processor cause the processor to determine that the candidate output address is an active address.

10. A communications path discovery system, comprising:
an address collection module to identify an input address for each intermediate entity from a plurality of intermediate entities in a communications link;
an identification module to identify a plurality of candidate output addresses for each intermediate entity; and
a correlation module to define a candidate output address from the plurality of candidate output addresses for each intermediate entity as an output address of that intermediate entity if a response to a data packet provided to that candidate output address is received from the input address of that intermediate entity.

11. The system of claim 10, further comprising a probe module to:
provide probe requests to the plurality of candidate output addresses for each intermediate entity;
receive responses to the probe requests; and
provide information associated with the probe requests to the identification module.

12. The system of claim 10, further comprising an aggregation module to generate a communications path descriptor based on the input address of each intermediate entity and output address of each intermediate entity.

13. A processor-readable medium storing code representing instructions that when executed at a processor cause the processor to, for each intermediate entity from a plurality of intermediate entities in a communications link:
identify an input address for that intermediate entity;
identify a plurality of candidate output addresses from an address range for that intermediate entity;
provide data packets to each candidate output address from the plurality of candidate output addresses for that intermediate entity until a response to a data packet from the data packets provided to a candidate output address is provided from the input address of that intermediate entity or a data packet is provided to each candidate output address from the plurality of candidate output addresses for that intermediate entity; and
define the candidate output address as an output address of the intermediate entity.

15. The processor-readable medium of claim 13, further storing code representing instructions that when executed at a processor cause the processor to define a communications path including the input address of each intermediate entity and the output address of each intermediate entity.

16. The processor-readable medium of claim 13, further storing code representing instructions that when executed at a processor cause the processor to, for each intermediate entity, determine the address range.

17. The processor-readable medium of claim 13, further storing code representing instructions that when executed at a processor cause the processor to, for each intermediate entity:
request an address mask from a subsequent intermediate entity; and
determine the address range based on the address mask.

18. The processor-readable medium of claim 13, wherein, for each intermediate entity, the data packet includes a port identifier at which no resource is available at that intermediate entity.

19. The processor-readable medium of claim 13, wherein, for each intermediate entity, the identifying the plurality of candidate output addresses includes determining that the plurality of candidate output addresses are active addresses.

20. The processor-readable medium of claim 13, wherein, for each intermediate entity, the response to the data packet provided to the candidate output address is a port unreachable response.
